(19) United States
(12) Patent Application Publication
(10) Pub. No.: US 2002/0166315 A1
(43) Pub. Date: Nov. 14, 2002

(54) Lawn mower zipper bag/grass catcher

(76) Inventor: Edward Babineaux, Houston, TX (US)

Correspondence Address: EDWARD BABINEAUX, 794 NORMANDY DRIVE # 933, HOUSTON, TX, 77015, US

(21) Appl. No.: 09/851,000

(22) Filed: May 9, 2001

(51) Int. Cl. A01D 19/00

(52) U.S. Cl. 56/202

(57) ABSTRACT

The lawn mower zipper bag grass catcher is new in the art of lawn mower bags. All previously existing lawn mower bags has no side opening with a zipper for the discharge of grass.

### BACKGROUND OF THE INVENTION

This invention relates generally to a grass catcher for use with a rear discharge lawn mower and particulary to grass catcher with a side opening comprise by a zipper to accommodate the opening.

Most lawn mowers are provided with a discharge opening adapted for installation of a grass catcher so the grass catcher must be remove from the lawn mower to empty the grass catcher. Conventional lawn mower catchers present a disadvantage that the catcher must be remove from the lawn mower to be emptied, than reconnect the cathcer to the lawn mower. A lawn mower zipper bag grass catcher will eliminate the necessity of disconnecting and reconnecting the catcher to the lawn mower.

It is an advantage to provide a grass catcher with a simply installed side opening with a zipper.

This devise provides an improvement over other known catchers and inexpensive to manufacture.

### SUMMARY OF THE INVENTION

The lawn mower zipper bag is a grass catcher with a simply installed side opening with a zipper that does not need disconnecting from the lawn mower.

The advantage of the lawn mower zipper bag grass catcher over the conventional lawn mower grass cathcer, is that the conventional lawn mower grass catcher must be remove from the lawn mower for the grass in the catcher to be emptied, than reconnect the catcher to the lawn mower.

The object of this invention is to provide a grass catcher that is easy to operate and simple to manufacture.

### DESCRIPTION OF THE INVENTION

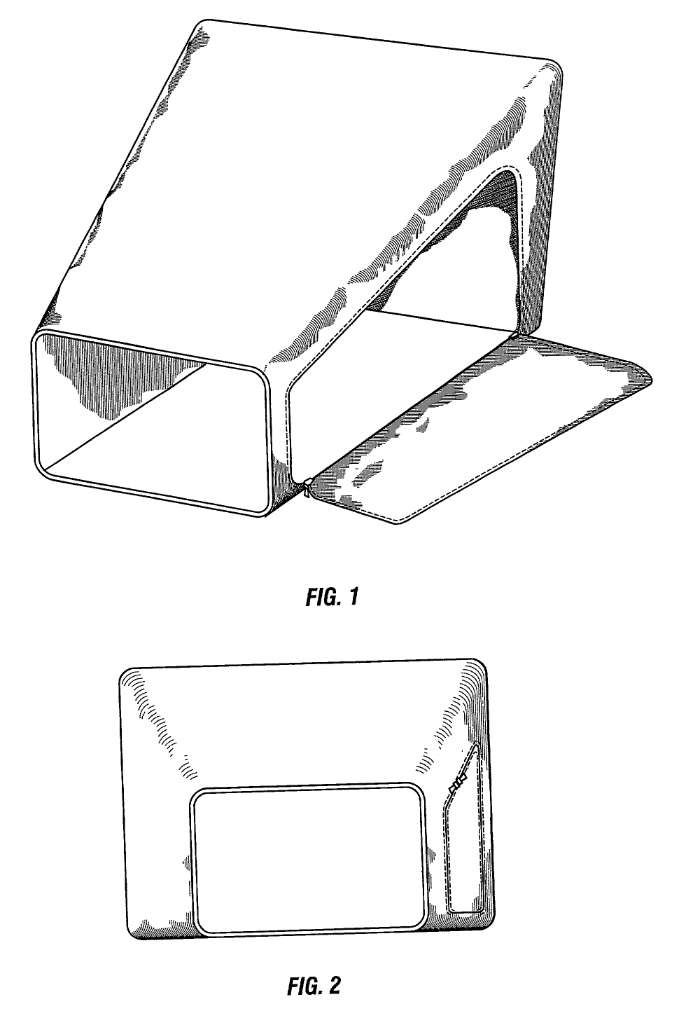

FIG. 1 indicates an opening for the disposal of grass

FIG. 2 indicates the catcher opening from which the grass will enter the catcher

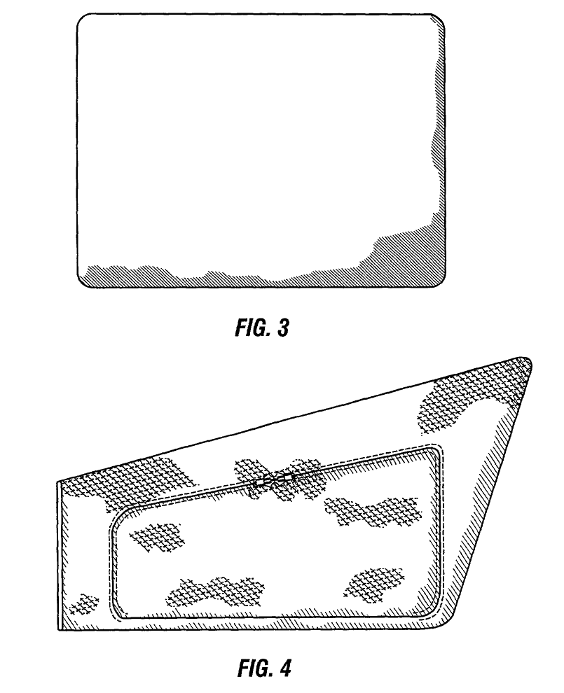

FIG. 3 indicates the rear of the grass catcher

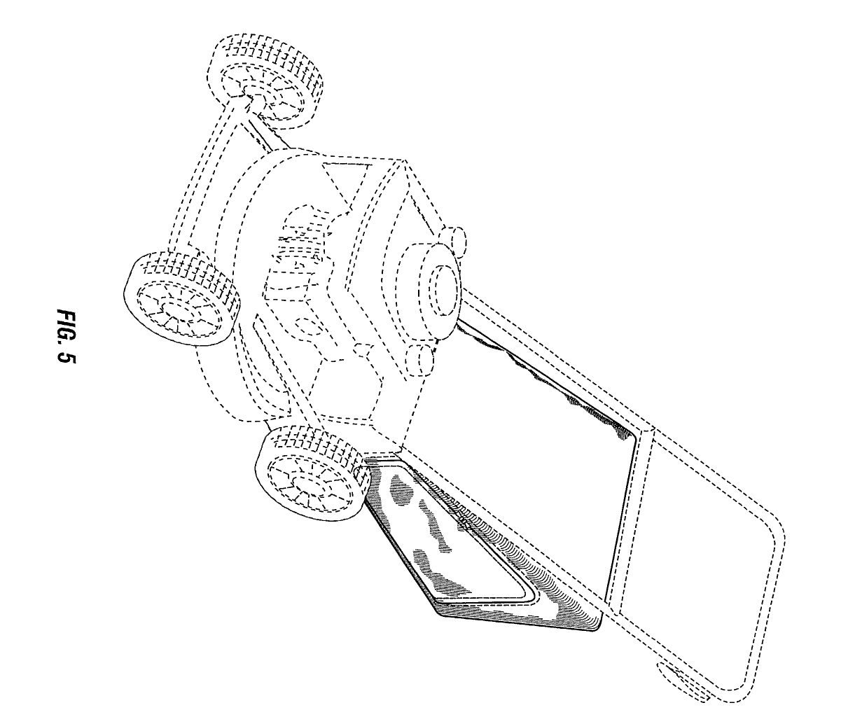

FIGS. 4&5 will be understood that the grass catcher is intended to be use with a lawn mower of the type witha side opening and closing with the use of a zipper

### DESCRIPTION OF THE PERFERRED EMBODIMENT

The grass catcher is made of a non-rigid favric. A zipper that is a fastener consisting of two rows of metal or plastic teeth on strips of tape and sliding piece that closes an opening by drawing the teeth together.

This grass catcher is for use with a lawn mower having a rearwardly disposed discharge opening. The catcher is to zip open ans close from the side position of the catcher.

The older type of grass catcher present a disadvantage that the grass catcher must be remove from the lawn mower to empty the grass, than reconnect the catcher to teh lawn mower.

The improvement is the lawn mower zipper bag grass catcher doesn't need to be disconnected from the lawn mower to the empty the grass from the catcher. To empty the grass from the zipper bag grass catcher, is to simply zip open teh grass catcher, empty the grass. than close the catcher from the side position by the use of the zipper.

What I claim as my invention is:

1. A lawn mower grass catcher bag with a zipper attachment.
